(19) United States
(12) Patent Application Publication
(10) Pub. No.: US 2014/0212569 A1
(43) Pub. Date: Jul. 31, 2014

(54) SANDWICH FISH SAUSAGE AND PROCESSING METHOD THEREOF

(71) Applicant: Zengyu Hui, Zhucheng (CN)

(72) Inventor: Zengyu Hui, Zhucheng (CN)

(73) Assignee: Shandong Huifa Food Corporation Co., Ltd., Zhucheng (CN)

(21) Appl. No.: 14/125,076

(22) PCT Filed: Aug. 8, 2012
(86) PCT No.: PCT/CN2012/079811

§ 371 Date: Dec. 9, 2013

(51) Int. Cl. A22C 11/00; A23L 1/317; A23L 1/325

(52) U.S. Cl. CPC A22C 11/00; A23L 1/3255; A23L 1/3175
USPC 426/643

(57) ABSTRACT

The present invention discloses a sandwich fish sausage and a processing method thereof. Curdlan, fish, chicken, beef and the like are reasonably matched and processed to fabricate the sausage. As compared with the sausage without the curdlan, the sausage added with the curdlan is more tender and smooth in taste, the water-retaining property and stability of the sausage are enhanced, and the yield is greatly improved. The sausage meets the market demand and modern nutrition requirements, satisfies requirements of various consumers and consumer channels, and especially has the effect of keeping fitness and losing weight for women to eat. The sandwich fish sausage of the present invention is delicious in taste and good in flavor, contains various vitamins A, D, B2, B12 and PP and other nutrients required by human body, and is easily to digest and absorb.

### CROSS-REFERENCE TO RELATED APPLICATIONS

This application is the U.S. national phase of International Application No. PCT/CN2012/079811, filed on 8 Aug. 2012, the entire contents of which is hereby incorporated by reference.

### BACKGROUND OF THE INVENTION

1. Field of the Invention

The present invention relates to a sausage and a processing method for mass production thereof.

2. Background of the Invention

Sausage is produced by using auxiliary meat through the processing steps of vacuum irrigating, smoking and cooking, vacuum aseptic packaging and the like. Sausage has the primary ingredients of auxiliary meat, starch, flavorings and the like. However, with the increase of people's living standards, disorders like high blood pressure, high cholesterol, high blood glucose (which are also referred to as “three high”) commonly occur, so that many people cannot enjoy the delicious sausage. Further, due to the single nutrient, it cannot meet people's requirements regarding taste and nutrition of sausage.

### BRIEF SUMMARY OF THE INVENTION

The technical problem to be solved by the present invention is to provide a sandwich fish sausage which not only is delicious in taste and good in flavor, but also contains various vitamins required by human body.

In order to solve the above technical problem, the technical solution of the present invention lies in a sandwich fish sausage, which comprises the following raw materials in parts by weight:

a first raw material: raw materials for wrapper fillings of the sandwich fish sausage

fish 20-30 parts; curdlan 3-5 parts; soy isolate protein powder 0.5-2 parts; salad oil 5-10 parts; water 40-45 parts; starch 5-10 parts; salts 1-2 parts; sugars 1-2 parts; gourmet powders 0.05-0.5 parts; white pepper powder 0.05-0.1 parts; meat flavor powders 0.05-0.12 parts; shrimp powder 0.02-0.05 parts; meat flavor oil 0.05-0.1 parts; seafood flavor: 0.05-0.1 parts;

a second raw material: raw materials for sausage fillings of the sandwich fish sausage

beef 20-30 parts; chicken 20-30 parts; chicken skin 5-10 parts; corn 2-5 parts; textured soy protein 20-30 parts; water 5-10 parts; salts 1-2 parts; sugars 1-2 parts; gourmet powders 0.05-0.5 parts; white pepper powder 0.05-0.1 parts; sesame oil 0.5-0.3 parts; meat flavor paste 0.05-0.5 parts; red yeast rice 0.005-0.01 parts;

a third raw material: raw materials for pigment fillings of the sandwich fish sausage

fish 25-40 parts; salad oil 3-5 parts; water 30-40 parts; starch 30-40 parts; salts 0.5-1 parts; chili oil 0.1-0.3;

said first, second and third raw materials are formed into fillings, and during molding the sandwich fish sausage, the first, second and third raw materials are added in the following parts by weight: the first raw material 40-60 parts, the second raw material 30-40 parts, the third raw material 10-20 parts; said second raw material is located in an inner part of the sandwich fish sausage, said first raw material is located in an outer part of the sandwich fish sausage and wraps said second raw material, and the third raw material is attached to said first raw material in the form of strips or spirals.

As a preferred technical solution, said first, second and third raw materials are added in the following parts by weight: the first raw material 50 parts; the second raw material 35 parts; and the third raw material 15 parts.

The present invention further provides a processing method of the above sandwich fish sausage, which comprises steps of:

(1) processing steps of raw materials for wrapper fillings of the sandwich fish sausage, which comprise

emulsifying step: pouring the accurately weighed ice-water into a chopper, pouring the prepared soy isolate protein powder into the chopper, chopping at 1700-1900 rpm so that there is no grain, chopping at 3400-3800 rpm, throwing evenly the prepared salad oil into the chopper, chopping to a creamy state to form an emulsion slurry, wherein the temperature is kept between 1 and 4° C. during this step;

chopping step: cutting fish into pieces with a frozen meat cutting machine, keeping the temperature between ±2° C.; chopping fish at 1700-1900 rpm into a diced shape with a size of fingertip, then adding salts and chopping at 3400-3800 rpm for 40-60 seconds; pouring curdlan into the chopper chopping at 150-250 rpm into a uniform state, adding evenly the remaining fine materials of the prepared the first raw material and continuing to chopping at 150-250 rpm into a uniform state, adding the prepared emulsion slurry, chopping at 150-250 rpm into a uniform state, and then chopping at 1700-1900 rpm into a uniform state; placing the chopped fillings into a filling machine, filling in a production tracking record and a production tracking card, and moving the filling machine in a standing room, wherein the storage time of each batch is shorter than 120 minutes;

(2) processing steps of raw materials for sausage fillings of the sandwich fish sausage, which comprise

cutting step: cutting chicken into pieces with the frozen meat cutting machine, keeping the temperature between ±2° C.; grinding chicken skin into pieces in the frozen state with a 4-8 mm grinder plate, and keeping the temperature between 0 and 4° C.;

chopping step: chopping chicken at 1700-1900 rpm into a diced shape with a size of 5*5*5 mm³-10*10*10 mm³, then adding salts, sugars, gourmet powders and chopping at 150-250 rpm for 5-15 seconds, adding red yeast rice and chopping at 1700-1900 rpm for 5-15 seconds; adding ice-water and chopping at 1700-1900 rpm for about 15-25 seconds, adding the remaining flavor materials of the second raw material and the textured soy protein and chopping at 150-250 rpm into a uniform state, further chopping at 1700-1900 rpm for about 10-20 seconds; adding chicken skin and chopping at 1700-1900 rpm into a uniform state in which chicken skin grains should exist, and finally pouring corn kernels into the chopper and chopping at 150-250 rpm into a uniform state; fully merging the meat fillings by chopping and maintaining the temperature between 2 and 8° C.; placing the chopped meat materials into a meat filling machine, wherein the filling machine is required to be sterilized by 120-180 ppm chlorine dioxide for 3-7 minutes and then cleaned up with clean water before use; filling in a production tracking record and a production tracking card, moving the filling machine in a standing room, wherein the storage time of each batch is shorter than 120 minutes;

(3) processing steps of raw materials for pigment fillings of the sandwich fish sausage, which comprise

materials preparing step: unfreezing fish to a central temperature between −2 and 2° C. so that the chicken is not loose but soft as a whole and can be cut up with a knife, wherein it is required that the chicken has a smell inherent for fresh fish, no peculiar smell, no fishbone, no black skin, no sand grain and no impurity;

chopping step: weighing fish and putting into the chopper, chopping at 150-250 rpm for 2-3 cycles, and chopping at 1700-1900 rpm for 50-70 seconds; adding salts, chopping at 150-250 rpm for 2-3 cycles, chopping at 1700-1900 rpm for 50-70 seconds, and chopping at 3400-3800 rpm for 50-70 seconds; adding chili oil, chopping at 1700-1900 rpm for 15-25 seconds, chopping at 3400-3800 rpm for 8-12 seconds; adding water, starch, and chopping at 1700-1900 rpm for 30-50 seconds; finally adding salad oil, chopping at 1700-1900 rpm into a state in which the fillings have a fine, shiny and sticky surface and contain no small grain;

(4) sandwich fish sausage molding step

checking whether the power supply of a pump molding machine and a sandwich crab row machine has been connected, whether the machines can operate normally, whether a frequency converter can control the speed of the pump molding machine, finally checking the wear and operation conditions of nylon gears, replacing timely in case of serious wear, and repairing timely in case of non-smooth operation; in case that the machines are in normal operation, connecting a discharge port of the pump molding machine and a feeding port of the sandwich crab row machine with a non-toxic plastic pipe, and clamping tightly with a clip;

filling up a hopper of the pump molding machine with sausage fillings, and filling up two hoppers of the sandwich crab row machine with wrapper fillings and pigment fillings respectively by using a stainless steel basin, wherein during adding fillings, it is required to add a small amount frequently and avoid spreading the fillings; starting the pump molding machine and the sandwich crab row machine, so that the sausage fillings output from the pump molding machine discharge port are transferred to the feeding port of the sandwich crab row machine, and the discharge port of the sandwich crab row machine molds to form fresh sandwich fish sausage in the form of a long strip;

timely adjusting the hobbing speed of the sandwich crab row machine according to the production requirements, dividing the sandwich fish sausage in the form of a long strip into segments (each segment having a weight of 50 g and a length of 10 cm), and timely cleaning up debris (filling slags, dirts, oils and the like) on the machines during production;

directly dropping the sandwich fish sausage after molding and cutting into a hot pool for cooking, wherein water in the hot pool is set between 90 and 95° C. and cooking lasts for 8-12 minutes, and wherein the product is heated to a central temperature up to 70-80° C. for 1 minute or more, so as to ensure that the product is well cooked and sterilized;

(5) precooling and arranging step

immediately placing the cooked product into a precooling pool for fast precooling, and cooling the product to a central temperature of 25° C. or less, wherein during packing in box, it is ensured that an IQF (Individual Quick Freezing) box should be clean and free of water, that the product should only be packed in a single layer during packing in box to avoid squeezing, and that the product should be arranged from top to bottom in the IQF car;

(6) product quick freezing step

quick freezing the products which have been confirmed as qualified according to the processing order uniformly with a full automated instant freezer, so that the products are packed at a central temperature of −18° C. or less;

(7) bagging, weighing and sealing step

packaging the products passing inspection (according to requirements of the customer), and detecting with a metal detector whether there is any metal substance in the packaged products;

(8) packing step

correctly identifying the box from outside (according to requirements of the order); sealing the top of box with a tape, wherein the tape should be pasted flatly without wrinkles, and both sides of the tape are basically symmetric with respect to each other;

(9) storing step

refrigerating the packed and qualified products in a refrigeratory at −18° C. or less, wherein the product is kept at a temperature of −18° C. or less and the storage period is shorter than 12 months.

Due to the adoption of the above technical solution, the present invention has the following beneficial effects. Curdlan, fish, chicken, beef and the like are reasonably matched and processed to fabricate the sausage. As compared with the sausage without the curdlan, the sausage added with the curdlan is more tender and smooth in taste, the water-retaining property and stability of the sausage are enhanced, and the yield is greatly improved. The sausage meets the market demand and modern nutrition requirements, satisfies requirements of various consumers and consumer channels, and especially has the effect of keeping fitness and losing weight for women to eat. The sandwich fish sausage of the present invention is delicious in taste and good in flavor, contains various vitamins A, D, B2, B12 and PP and other nutrients required by human body, and is easily to digest and absorb.

### DETAILED DESCRIPTION OF THE INVENTION

In the following detailed description, some exemplary embodiments of the present invention will be described in an illustrative way. It is apparent for the ordinary skilled in the art that various modifications can be made to the described embodiments without departing from the spirit and scope of the present invention.

A sandwich fish sausage comprises the following raw materials in parts by weight:

a first raw material: raw materials for wrapper fillings of the sandwich fish sausage

fish 20-30 parts; curdlan 3-5 parts; soy isolate protein powder 0.5-2 parts; salad oil 5-10 parts; water 40-45 parts; starch 5-10 parts; salts 1-2 parts; sugars 1-2 parts; gourmet powders 0.05-0.5 parts; white pepper powder 0.05-0.1 parts; meat flavor powders 0.05-0.12 parts; shrimp powder 0.02-0.05 parts; meat flavor oil 0.05-0.1 parts; seafood flavor: 0.05-0.1 parts;

a second raw material: raw materials for sausage fillings of the sandwich fish sausage

beef 20-30 parts; chicken 20-30 parts; chicken skin 5-10 parts; corn 2-5 parts; textured soy protein 20-30 parts; water 5-10 parts; salts 1-2 parts; sugars 1-2 parts; gourmet powders 0.05-0.5 parts; white pepper powder 0.05-0.1 parts; sesame oil 0.5-0.3 parts; meat flavor paste 0.05-0.5 parts; red yeast rice 0.005-0.01 parts;

a third raw material: raw materials for pigment fillings of the sandwich fish sausage

fish 25-40 parts; salad oil 3-5 parts; water 30-40 parts; starch 30-40 parts; salts 0.5-1 parts; chili oil 0.1-0.3;

said first, second and third raw materials are formed into fillings, and during molding the sandwich fish sausage, the first, second and third raw materials are added in the following parts by weight: the first raw material 40-60 parts; the second raw material 30-40 parts; the third raw material 10-20 parts; said second raw material is located in an inner part of the sandwich fish sausage, said first raw material is located in an outer part of the sandwich fish sausage and wraps said second raw material, and the third raw material is attached to said first raw material in the form of strips or spirals.

In the present embodiment, said first, second and third raw materials are added in the following parts by weight: the first raw material 50 parts; the second raw material 35 parts; and the third raw material 15 parts.

A processing method of a sandwich fish sausage comprises steps of:

(1) processing steps of raw materials for wrapper fillings of the sandwich fish sausage, which comprise

emulsifying step: pouring the accurately weighed ice-water into a chopper, pouring the prepared soy isolate protein powder into the chopper, chopping at 1700-1900 rpm so that there is no grain, chopping at 3400-3800 rpm, throwing evenly the prepared salad oil into the chopper, chopping to a creamy state to form an emulsion slurry, wherein the temperature is kept between 1 and 4° C. during this step;

chopping step: cutting fish into pieces with a frozen meat cutting machine, keeping the temperature between ±2° C.; chopping fish at 1700-1900 rpm into a diced shape with a size of fingertip, then adding salts and chopping at 3400-3800 rpm for 40-60 seconds; pouring curdlan into the chopper chopping at 150-250 rpm into a uniform state, adding evenly the remaining fine materials of the prepared the first raw material and continuing to chopping at 150-250 rpm into a uniform state, adding the prepared emulsion slurry, chopping at 150-250 rpm into a uniform state, and then chopping at 1700-1900 rpm into a uniform state; placing the chopped fillings into a filling machine, filling in a production tracking record and a production tracking card, and moving the filling machine in a standing room, wherein the storage time of each batch is shorter than 120 minutes;

(2) processing steps of raw materials for sausage fillings of the sandwich fish sausage, which comprise

cutting step: cutting chicken into pieces with the frozen meat cutting machine, keeping the temperature between ±2° C.; grinding chicken skin into pieces in the frozen state with a 4-8 mm grinder plate, and keeping the temperature between 0 and 4° C.;

chopping step: chopping chicken at 1700-1900 rpm into a diced shape with a size of 5*5*5 mm³-10*10*10 mm³, then adding salts, sugars, gourmet powders and chopping at 150-250 rpm for 5-15 seconds, adding red yeast rice and chopping at 1700-1900 rpm for 5-15 seconds; adding ice-water and chopping at 1700-1900 rpm for about 15-25 seconds, adding the remaining flavor materials of the second raw material and the textured soy protein and chopping at 150-250 rpm into a uniform state, further chopping at 1700-1900 rpm for about 10-20 seconds; adding chicken skin and chopping at 1700-1900 rpm into a uniform state in which chicken skin grains should exist, and finally pouring corn kernels into the chopper and chopping at 150-250 rpm into a uniform state; fully merging the meat fillings by chopping and maintaining the temperature between 2 and 8° C.; placing the chopped meat materials into a meat filling machine, wherein the filling machine is required to be sterilized by 120-180 ppm chlorine dioxide for 3-7 minutes and then cleaned up with clean water before use; filling in a production tracking record and a production tracking card, moving the filling machine in a standing room, wherein the storage time of each batch is shorter than 120 minutes;

(3) processing steps of raw materials for pigment fillings of the sandwich fish sausage, which comprise

materials preparing step: unfreezing fish to a central temperature between −2 and 2° C. so that the chicken is not loose but soft as a whole and can be cut up with a knife, wherein it is required that the chicken has a smell inherent for fresh fish, no peculiar smell, no fishbone, no black skin, no sand grain and no impurity;

chopping step: weighing fish and putting into the chopper, chopping at 150-250 rpm for 2-3 cycles, and chopping at 1700-1900 rpm for 50-70 seconds; adding salts, chopping at 150-250 rpm for 2-3 cycles, chopping at 1700-1900 rpm for 50-70 seconds, and chopping at 3400-3800 rpm for 50-70 seconds; adding chili oil, chopping at 1700-1900 rpm for 15-25 seconds, chopping at 3400-3800 rpm for 8-12 seconds; adding water, starch, and chopping at 1700-1900 rpm for 30-50 seconds; finally adding salad oil, chopping at 1700-1900 rpm into a state in which the fillings have a fine, shiny and sticky surface and contain no small grain;

(4) sandwich fish sausage molding step

checking whether the power supply of a pump molding machine and a sandwich crab row machine has been connected, whether the machines can operate normally, whether a frequency converter can control the speed of the pump molding machine, finally checking the wear and operation conditions of nylon gears, replacing timely in case of serious wear, and repairing timely in case of non-smooth operation; in case that the machines are in normal operation, connecting a discharge port of the pump molding machine and a feeding port of the sandwich crab row machine with a non-toxic plastic pipe, and clamping tightly with a clip;

filling up a hopper of the pump molding machine with sausage fillings, and filling up two hoppers of the sandwich crab row machine with wrapper fillings and pigment fillings respectively by using a stainless steel basin, wherein during adding fillings, it is required to add a small amount frequently and avoid spreading the fillings; starting the pump molding machine and the sandwich crab row machine, so that the sausage fillings output from the pump molding machine discharge port are transferred to the feeding port of the sandwich crab row machine, and the discharge port of the sandwich crab row machine molds to form fresh sandwich fish sausage in the form of a long strip;

timely adjusting the hobbing speed of the sandwich crab row machine according to the production requirements, dividing the sandwich fish sausage in the form of a long strip into segments (each segment having a weight of 50 g and a length of 10 cm), and timely cleaning up debris (filling slags, dirts, oils and the like) on the machines during production;

directly dropping the sandwich fish sausage after molding and cutting into a hot pool for cooking, wherein water in the hot pool is set between 90 and 95° C. and cooking lasts for 8-12 minutes, and wherein the product is heated to a central temperature up to 70-80° C. for 50-70 seconds or more, so as to ensure that the product is well cooked and sterilized;

(5) precooling and arranging step

immediately placing the cooked product into a precooling pool for fast precooling, and cooling the product to a central temperature of 25° C. or less, wherein during packing in box, it is ensured that an IQF box should be clean and free of water, that the product should only be packed in a single layer during packing in box to avoid squeezing, and that the product should be arranged from top to bottom in the IQF car;

(6) product quick freezing step

quick freezing the products which have been confirmed as qualified according to the processing order uniformly with a full automated instant freezer, so that the products are packed at a central temperature of −18° C. or less;

(7) bagging, weighing and sealing step

packaging the products passing inspection according to requirements of the customer, and detecting with a metal detector whether there is any metal substance in the packaged products;

(8) packing step

correctly identifying the box from outside according to requirements of the order; sealing the top of box with a tape, wherein the tape should be pasted flatly without wrinkles, and both sides of the tape are basically symmetric with respect to each other;

(9) storing step

refrigerating the packed and qualified products in a refrigeratory at −18° C. or less, wherein the product is kept at a temperature of −18° C. or less and the storage period is0 shorter than 12 months.

The sandwich fish sausage of the present invention features that the wrapper is fine and tender, the fillings have oil-like taste and are chewy and crispy, and the product has a rich, smooth and delicious taste as a whole. The sandwich fish sausage is rich in various vitamins A, D, B2, B12 and PP and other nutrients required by human body, and is easily to digest and absorb. It is a product that has various functions such as decreasing cholesterol and blood glucose, anti-cancer, constipation and the like.

All of the chopper, pump molding machine and crab row machine applied in the method of the invention are commonly used machines in the food industry, and thus are not repeated for simplicity. The sandwich crab row machine applied in the present invention is XP300 type sandwich crab row machine produced by Quanzhou Tianshun Foodstuff Machinery Co., Ltd., which has the functions of producing a sandwich rod-shape food from two kinds of raw materials, and attaching decorative strips (in the form of strips or spirals) to the outer surface of the food. The decorative strips in the present invention further play the role of seasoning and nutrition.

It has to be noted that the basic principle, main features, and advantages of the present invention have been described above. It's understood by the skilled in the art that the present invention is not limited to the above embodiments. These embodiments and the description only describe the principle of the present invention. Various modifications and improvements to the present invention can be made without departing from the spirit and scope of the present invention, and all such modifications and improvements fall within the protection scope of the present invention. The protection scope of the present invention is defined in the following claims and the equivalents thereto.

1. A sandwich fish sausage, characterized in that, the sandwich fish sausage comprise the following raw materials in parts by weight:
a first raw material: raw materials for wrapper fillings of the sandwich fish sausage
fish 20-30 parts; curdlan 3-5 parts; soy isolate protein powder 0.5-2 parts; salad oil 5-10 parts; water 40-45 parts; starch 5-10 parts; salts 1-2 parts; sugars 1-2 parts;
gourmet powders 0.05-0.5 parts; white pepper powder 0.05-0.1 parts; meat flavor powders 0.05-0.12 parts; shrimp powder 0.02-0.05 parts; meat flavor oil 0.05-0.1 parts; seafood flavor: 0.05-0.1 parts;
a second raw material: raw materials for sausage fillings of the sandwich fish sausage
beef 20-30 parts; chicken 20-30 parts; chicken skin 5-10 parts; corn 2-5 parts; textured soy protein 20-30 parts; water 5-10 parts; salts 1-2 parts; sugars 1-2 parts; gourmet powders 0.05-0.5 parts; white pepper powder 0.05-0.1 parts; sesame oil 0.5-0.3 parts; meat flavor paste 0.05-0.5 parts; red yeast rice 0.005-0.01 parts;
a third raw material: raw materials for pigment fillings of the sandwich fish sausage
fish 25-40 parts; salad oil 3-5 parts; water 30-40 parts; starch 30-40 parts; salts 0.5-1 parts; chili oil 0.1-0.3;
said first, second and third raw materials are formed into fillings, and during molding the sandwich fish sausage, the first, second and third raw materials are added in the following parts by weight: the first raw material 40-60 parts, the second raw material 30-40 parts, the third raw material 10-20 parts; said second raw material is located in an inner part of the sandwich fish sausage, said first raw material is located in an outer part of the sandwich fish sausage and wraps said second raw material, and the third raw material is attached to said first raw material in the form of strips or spirals.

2. The sandwich fish sausage of claim 1, characterized in that, said first, second and third raw materials are added in the following parts by weight: the first raw material 50 parts; the second raw material 35 parts; and the third raw material 15 parts.

3. A processing method of the sandwich fish sausage of claim 1, characterized in that, the processing method comprises steps of:
(1) processing steps of raw materials for wrapper fillings of the sandwich fish sausage, which comprise
emulsifying step: pouring the accurately weighed ice-water into a chopper, pouring the prepared soy isolate protein powder into the chopper, chopping at 1700-1900 rpm so that there is no grain, chopping at 3400-3800 rpm, throwing evenly the prepared salad oil into the chopper, chopping to a creamy state to form an emulsion slurry, wherein the temperature is kept between 1 and 4° C. during this step;
chopping step: cutting fish into pieces with a frozen meat cutting machine, keeping the temperature between ±2° C.; chopping fish at 1700-1900 rpm into a diced shape with a size of fingertip, then adding salts and chopping at 3400-3800 rpm for 40-60 seconds; pouring curdlan into the chopper chopping at 150-250 rpm into a uniform state, adding evenly the remaining fine materials of the prepared the first raw material and continuing to chopping at 150-250 rpm into a uniform state, adding the prepared emulsion slurry, chopping at 150-250 rpm into a uniform state, and then chopping at 1700-1900 rpm into a uniform state; placing the chopped fillings into a filling machine, filling in a production tracking record and a production tracking card, and moving the filling machine in a standing room, wherein the storage time of each batch is shorter than 120 minutes;
(2) processing steps of raw materials for sausage fillings of the sandwich fish sausage, which comprise
cutting step: cutting chicken into pieces with the frozen meat cutting machine, keeping the temperature between ±2° C.; grinding chicken skin into pieces in the frozen state with a 4-8 mm grinder plate, and keeping the temperature between 0 and 4° C.;
chopping step: chopping chicken at 1700-1900 rpm into a diced shape with a size of 5*5*5 mm³-10*10*10 mm³, then adding salts, sugars, gourmet powders and chopping at 150-250 rpm for 5-15 seconds, adding red yeast rice and chopping at 1700-1900 rpm for 5-15 seconds; adding ice-water and chopping at 1700-1900 rpm for about 15-25 seconds, adding the remaining flavor materials of the second raw material and the textured soy protein and chopping at 150-250 rpm into a uniform state, further chopping at 1700-1900 rpm for about 10-20 seconds; adding chicken skin and chopping at 1700-1900 rpm into a uniform state in which chicken skin grains should exist, and finally pouring corn kernels into the chopper and chopping at 150-250 rpm into a uniform state; fully merging the meat fillings by chopping and maintaining the temperature between 2 and 8° C.; placing the chopped meat materials into a meat filling machine, wherein the filling machine is required to be sterilized by 120-180 ppm chlorine dioxide for 3-7 minutes and then cleaned up with clean water before use; filling in a production tracking record and a production tracking card, moving the filling machine in a standing room, wherein the storage time of each batch is shorter than 120 minutes;
(3) processing steps of raw materials for pigment fillings of the sandwich fish sausage, which comprise
materials preparing step: unfreezing fish to a central temperature between −2 and 2° C. so that the chicken is not loose but soft as a whole and can be cut up with a knife, wherein it is required that the chicken has a smell inherent for fresh fish, no peculiar smell, no fishbone, no black skin, no sand grain and no impurity;
chopping step: weighing fish and putting into the chopper, chopping at 150-250 rpm for 2-3 cycles, and chopping at 1700-1900 rpm for 50-70 seconds; adding salts, chopping at 150-250 rpm for 2-3 cycles, chopping at 1700-1900 rpm for 50-70 seconds, and chopping at 3400-3800 rpm for 50-70 seconds; adding chili oil, chopping at 1700-1900 rpm for 15-25 seconds, chopping at 3400-3800 rpm for 8-12 seconds; adding water, starch, and chopping at 1700-1900 rpm for 30-50 seconds;
finally adding salad oil, chopping at 1700-1900 rpm into a state in which the fillings have a fine, shiny and sticky surface and contain no small grain;
(4) sandwich fish sausage molding step
checking whether the power supply of a pump molding machine and a sandwich crab row machine has been connected, whether the machines can operate normally, whether a frequency converter can control the speed of the pump molding machine, finally checking the wear and operation conditions of nylon gears, replacing timely in case of serious wear, and repairing timely in case of non-smooth operation; in case that the machines are in normal operation, connecting a discharge port of the pump molding machine and a feeding port of the sandwich crab row machine with a non-toxic plastic pipe, and clamping tightly with a clip;
filling up a hopper of the pump molding machine with sausage fillings, and filling up two hoppers of the sandwich crab row machine with wrapper fillings and pigment fillings respectively by using a stainless steel basin, wherein during adding fillings, it is required to add a small amount frequently and avoid spreading the fillings; starting the pump molding machine and the sandwich crab row machine, so that the sausage fillings output from the pump molding machine discharge port are transferred to the feeding port of the sandwich crab row machine, and the discharge port of the sandwich crab row machine molds to form fresh sandwich fish sausage in the form of a long strip;
timely adjusting the hobbing speed of the sandwich crab row machine according to the production requirements, dividing the sandwich fish sausage in the form of a long strip into segments, and timely cleaning up debris on the machines during production;
directly dropping the sandwich fish sausage after molding and cutting into a hot pool for cooking, wherein water in the hot pool is set between 90 and 95° C. and cooking lasts for 8-12 minutes, and wherein the product is heated to a central temperature up to 70-80° C. for 1 minute or more, so as to ensure that the product is well cooked and sterilized;
(5) precooling and arranging step
immediately placing the cooked product into a precooling pool for fast precooling, and cooling the product to a central temperature of 25° C. or less, wherein during packing in box, it is ensured that an IQF box should be clean and free of water, that the product should only be packed in a single layer during packing in box to avoid squeezing, and that the product should be arranged from top to bottom in the IQF car;
(6) product quick freezing step
quick freezing the products which have been confirmed as qualified according to the processing order uniformly with a full automated instant freezer, so that the products are packed at a central temperature of −18° C. or less;
(7) bagging, weighing and sealing step
packaging the products passing inspection (according to requirements of the customer), and detecting with a metal detector whether there is any metal substance in the packaged products;
(8) packing step
correctly identifying the box from outside (according to requirements of the order); sealing the top of box with a tape, wherein the tape should be pasted flatly without wrinkles, and both sides of the tape are basically symmetric with respect to each other;
(9) storing step
refrigerating the packed and qualified products in a refrigeratory at −18° C. or less, wherein the product is kept at a temperature of −18° C. or less and the storage period is shorter than 12 months.

4. A processing method of the sandwich fish sausage of claim 2 characterized in that, the processing method comprises steps of:
(1) processing steps of raw materials for wrapper fillings of the sandwich fish sausage, which comprise
emulsifying step: pouring the accurately weighed ice-water into a chopper, pouring the prepared soy isolate protein powder into the chopper, chopping at 1700-1900 rpm so that there is no grain, chopping at 3400-3800 rpm, throwing evenly the prepared salad oil into the chopper, chopping to a creamy state to form an emulsion slurry, wherein the temperature is kept between 1 and 4° C. during this step;
chopping step: cutting fish into pieces with a frozen meat cutting machine, keeping the temperature between ±2° C.; chopping fish at 1700-1900 rpm into a diced shape with a size of fingertip, then adding salts and chopping at 3400-3800 rpm for 40-60 seconds; pouring curdlan into the chopper chopping at 150-250 rpm into a uniform state, adding evenly the remaining fine materials of the prepared the first raw material and continuing to chopping at 150-250 rpm into a uniform state, adding the prepared emulsion slurry, chopping at 150-250 rpm into a uniform state, and then chopping at 1700-1900 rpm into a uniform state; placing the chopped fillings into a filling machine, filling in a production tracking record and a production tracking card, and moving the filling machine in a standing room, wherein the storage time of each batch is shorter than 120 minutes;
(2) processing steps of raw materials for sausage fillings of the sandwich fish sausage, which comprise
cutting step: cutting chicken into pieces with the frozen meat cutting machine, keeping the temperature between ±2° C.; grinding chicken skin into pieces in the frozen state with a 4-8 mm grinder plate, and keeping the temperature between 0 and 4° C.;
chopping step: chopping chicken at 1700-1900 rpm into a diced shape with a size of 5*5*5 mm³-10*10*10 mm³, then adding salts, sugars, gourmet powders and chopping at 150-250 rpm for 5-15 seconds, adding red yeast rice and chopping at 1700-1900 rpm for 5-15 seconds; adding ice-water and chopping at 1700-1900 rpm for about 15-25 seconds, adding the remaining flavor materials of the second raw material and the textured soy protein and chopping at 150-250 rpm into a uniform state, further chopping at 1700-1900 rpm for about 10-20 seconds; adding chicken skin and chopping at 1700-1900 rpm into a uniform state in which chicken skin grains should exist, and finally pouring corn kernels into the chopper and chopping at 150-250 rpm into a uniform state; fully merging the meat fillings by chopping and maintaining the temperature between 2 and 8° C.; placing the chopped meat materials into a meat filling machine, wherein the filling machine is required to be sterilized by 120-180 ppm chlorine dioxide for 3-7 minutes and then cleaned up with clean water before use; filling in a production tracking record and a production tracking card, moving the filling machine in a standing room, wherein the storage time of each batch is shorter than 120 minutes;
(3) processing steps of raw materials for pigment fillings of the sandwich fish sausage, which comprise
materials preparing step: unfreezing fish to a central temperature between −2 and 2° C. so that the chicken is not loose but soft as a whole and can be cut up with a knife, wherein it is required that the chicken has a smell inherent for fresh fish, no peculiar smell, no fishbone, no black skin, no sand grain and no impurity;
chopping step: weighing fish and putting into the chopper, chopping at 150-250 rpm for 2-3 cycles, and chopping at 1700-1900 rpm for 50-70 seconds; adding salts, chopping at 150-250 rpm for 2-3 cycles, chopping at 1700-1900 rpm for 50-70 seconds, and chopping at 3400-3800 rpm for 50-70 seconds; adding chili oil, chopping at 1700-1900 rpm for 15-25 seconds, chopping at 3400-3800 rpm for 8-12 seconds; adding water, starch, and chopping at 1700-1900 rpm for 30-50 seconds;
finally adding salad oil, chopping at 1700-1900 rpm into a state in which the fillings have a fine, shiny and sticky surface and contain no small grain;
(4) sandwich fish sausage molding step
checking whether the power supply of a pump molding machine and a sandwich crab row machine has been connected, whether the machines can operate normally, whether a frequency converter can control the speed of the pump molding machine, finally checking the wear and operation conditions of nylon gears, replacing timely in case of serious wear, and repairing timely in case of non-smooth operation; in case that the machines are in normal operation, connecting a discharge port of the pump molding machine and a feeding port of the sandwich crab row machine with a non-toxic plastic pipe, and clamping tightly with a clip;
filling up a hopper of the pump molding machine with sausage fillings, and filling up two hoppers of the sandwich crab row machine with wrapper fillings and pigment fillings respectively by using a stainless steel basin, wherein during adding fillings, it is required to add a small amount frequently and avoid spreading the fillings; starting the pump molding machine and the sandwich crab row machine, so that the sausage fillings output from the pump molding machine discharge port are transferred to the feeding port of the sandwich crab row machine, and the discharge port of the sandwich crab row machine molds to form fresh sandwich fish sausage in the form of a long strip;
timely adjusting the hobbing speed of the sandwich crab row machine according to the production requirements, dividing the sandwich fish sausage in the form of a long strip into segments, and timely cleaning up debris on the machines during production;
directly dropping the sandwich fish sausage after molding and cutting into a hot pool for cooking, wherein water in the hot pool is set between 90 and 95° C. and cooking lasts for 8-12 minutes, and wherein the product is heated to a central temperature up to 70-80° C. for 1 minute or more, so as to ensure that the product is well cooked and sterilized;
(5) precooling and arranging step
immediately placing the cooked product into a precooling pool for fast precooling, and cooling the product to a central temperature of 25° C. or less, wherein during packing in box, it is ensured that an IQF box should be clean and free of water, that the product should only be packed in a single layer during packing in box to avoid squeezing, and that the product should be arranged from top to bottom in the IQF car;
(6) product quick freezing step
quick freezing the products which have been confirmed as qualified according to the processing order uniformly with a full automated instant freezer, so that the products are packed at a central temperature of −18° C. or less;
(7) bagging, weighing and sealing step
packaging the products passing inspection (according to requirements of the customer), and detecting with a metal detector whether there is any metal substance in the packaged products;
(8) packing step
correctly identifying the box from outside (according to requirements of the order); sealing the top of box with a tape, wherein the tape should be pasted flatly without wrinkles, and both sides of the tape are basically symmetric with respect to each other;
(9) storing step
refrigerating the packed and qualified products in a refrigeratory at −18° C. or less, wherein the product is kept at a temperature of −18° C. or less and the storage period is shorter than 12 months.
